(19) United States
(12) Patent Application Publication
(10) Pub. No.: US 2006/0213108 A1
(43) Pub. Date: Sep. 28, 2006

(54) Fishing rod

(76) Inventor: Igor Rozenberg, Toronto (CA)

Correspondence Address: BERESKIN AND PARR, 40 KING STREET WEST, BOX 401, TORONTO, ON, M5H 3Y2, CA

(21) Appl. No.: 11/088,944

(22) Filed: Mar. 25, 2005

(51) Int. Cl. A01K 87/00; A01K 97/12

(52) U.S. Cl. 43/18.1 R; 43/17

(57) ABSTRACT

A fishing rod includes a stable arm and a moveable arm. The stable arm has a first stable arm end and a second stable arm end. The moveable arm has a first moveable arm end and a second moveable arm end. The moveable arm is pivotally coupled to the stable arm and the second moveable arm end is biased to a first position remote from the second stable arm end.

### FIELD OF THE INVENTION

This invention relates to the field of fishing rods, with particular but by no means exclusive application to ice fishing rods.

### BACKGROUND OF THE INVENTION

Fishing rods having different stiffnesses, typically because they are made from different materials or have different shaft thicknesses, will provide different “action”. In other words, rods with different stiffnesses will react differently to tension on the fishing line, usually caused when a fish strikes the lure.

A fishing rod with more action will more easily deflect downwards as a result of tension on the line than will a fishing rod with greater stiffness and hence less action. This deflection provides a visual cue that a fish may be hooked on the line. While deflection may provide a visual cue, the stiffness of the rod also affects the leverage that the rod provides for pulling in a hooked fish. A fishing rod with more action will provide less leverage for pulling in fish.

A fishing rod having the appropriate stiffness must be selected for the specific fishing conditions and fish being sought. When fishing for small fish in calm water conditions, a fishing rod with significant action (and a low level of stiffness), will typically be preferred since a small fish will still be able to cause the rod to deflect. By contrast, in wavy conditions, the actions of the waves on a float attached to the fishing line may cause a rod with a high level of action to deflect, thereby providing a misleading visual cue to the fisherman. Similarly, if heavier fish are sought, a stiffer rod will be preferred, to provide sufficient leverage for pulling in the fish. A fisherman may want to fish for different types of fish and/or in different types of conditions on a fishing trip, each type of fish or condition requiring a different rod with a different type of action.

Accordingly, the inventor has recognized the need for an improved fishing rod and assembly which can be modified to provide different action for different types of fish and/or fishing conditions.

### SUMMARY OF THE INVENTION

The fishing rod of the present invention includes a stable arm member, a joining member and a handle. The stable arm member has a first stable arm end and a second stable arm end. The joining member has a first joining member end and a second joining member end, wherein the first joining member end is configured to releasably engage the second stable arm end. The handle has a first handle end and a second handle end, and wherein the first handle end is operatively coupled to the second joining member end.

In another aspect, the fishing rod of the present invention includes a joining member and a handle. The joining member has a first joining member end and a second joining member end. The first joining member end is configured to releasably engage a second stable arm end of a stable arm member having a first stable arm end and the second stable arm end. The handle has a first handle end and a second handle end, wherein the first handle end is operatively coupled to the second joining member end.

In yet another aspect, the present invention is directed towards a kit having a fishing rod and a plurality of stable arm members. The fishing rod includes a joining member and a handle. The joining member has a first joining member end and a second joining member end. The first joining member end is configured to releasably engage a second stable arm end of a stable arm member having a first stable arm end and the second stable arm end. The handle has a first handle end and a second handle end, wherein the first handle end is operatively coupled to the second joining member end. Each stable arm member has a different stiffness than every other stable arm member.

In a further aspect, the present invention is directed towards a fishing rod including a stable arm member having a first stable arm end and a second stable arm end and a handle having a first handle end and a second handle end, wherein the first handle end is configured to releasably engage the second stable arm end.

In yet a further aspect, the present invention is directed towards a fishing rod comprising a handle, wherein the handle is substantially tubular and comprises an interior region, and wherein the handle includes an access port through which the interior region may be accessed.

### BRIEF DESCRIPTION OF THE DRAWINGS

The present invention will now be described, by way of example only, with reference to the following drawings, in which like reference numerals refer to like parts and in which:

FIG. 1A is a side view of a first configuration of a fishing rod having a stable arm and a moveable arm, made in accordance with the present invention;

FIG. 1B is a side view of a second configuration of a fishing rod having a stable arm, made in accordance with the present invention;

FIG. 2 is a side view of components of the fishing rod of FIG. 1A;

FIG. 3A is a top perspective view of a first type of line guide of the fishing rod of FIG. 1A;

FIG. 3B is a side perspective view of a second type of line guide of the fishing rod of FIG. 1A;

FIG. 3C is a bottom rearward perspective view of a joining member of the fishing rod of FIG. 1A;

FIG. 3D is a front end view of the joining member of FIG. 3C;

FIG. 3E is a bottom perspective view of a butt end of the fishing rod of FIG. 1A;

FIG. 3F is an end view of the central cylinder of the fishing rod of FIG. 1A;

FIG. 4A is a top view of a group of replacement stable arms; and

FIG. 4B is a side view of the components of a group of replacement moveable arms.

### DETAILED DESCRIPTION OF THE INVENTION

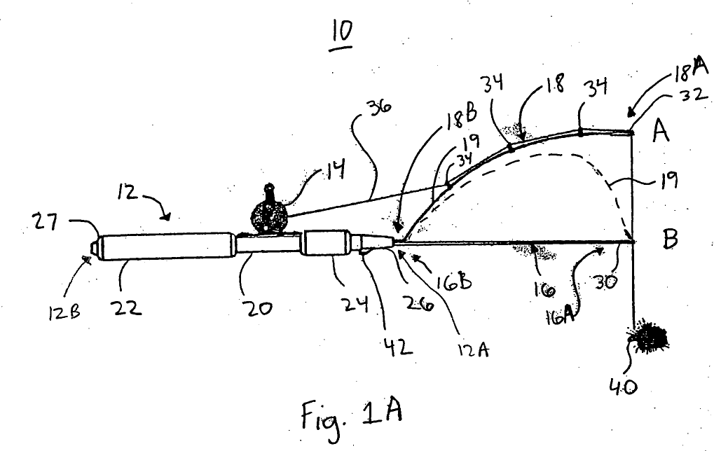

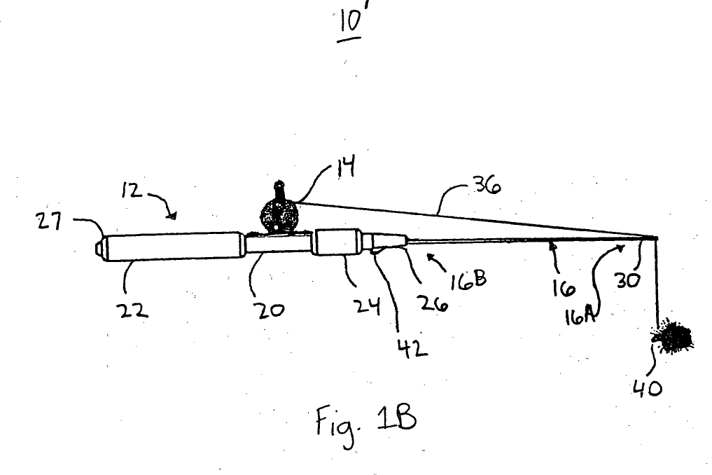

Referring simultaneously to FIGS. 1A, 2 and 3A-3F and 4A and 4B, illustrated therein is a fishing rod, referred to generally as 10, made in accordance with the present invention. The fishing rod 10 comprises a handle 12 (having a first handle end 12A and a second handle end 12B), a fishing line reel 14, and a stable arm 16 (having a first stable arm end 16A and a second stable arm end 16B). The rod 10 may also include a moveable arm 18 (having a first moveable arm end 18A and a second moveable arm end 18B).

The handle 12 preferably includes a central cylinder 20 (or other substantially tubular shaft), the ends of which are preferably coterminous with the handle ends 12A, 12B. The cylinder 20 has a hollow interior region, shown generally as 21. The rear handle end 12B forms an open access port 20A, through which the interior region 21 may be accessed. Typically, the access port 20A will be the open end face of the central cylinder 20. A knob or butt end 27 may be removably inserted into the second or rear handle end 12B to close the access port 20A. The butt end 27 may be removed when access to the interior region 21 is desired. The butt end 27 and the second or rear handle end 12B may be correspondingly configured such that the butt end 27 releasably engages the rear handle end 12B through interlocking threads or by friction fit, although other releasable engagement configurations are possible.

The handle 12 also includes a joining member 26 (having a first joining member end 26A and a second joining member end 26B) mounted either fixedly or releasably to the front end 12A of the handle shaft 20. If the joining member 26 is releasably mounted to the handle shaft 20, such releasable engagement again may be effected through friction fitting (eg. of the second joining member end 26B within the front handle end 20A) or interlocking threads. As well, if the joining member 26 is releasably mounted to the handle shaft 20, the member 26 may provide access to the interior region 21.

First grip member 22 and a second grip member 24 may be mounted over the tubular member 20. The grip members 22, 24 may be formed of rubber, durable foam or other material which facilitates the user's gripping of the handle 12. Screws or other means may be used to mount the reel 14 to the central cylinder 20.

The stable arm 16 may be a shaft 17 of fibreglass or graphite composite or other appropriate material as may be used in standard fishing rods. The stable arm 16 will have a first stiffness, providing a certain desired amount of action. The first stable arm end 16A may include a line guide 30 fixed to the shaft, while the second stable arm end 16B is configured to be releasably engaged by the joining member 26.

As will be understood, the first joining member end 26A is provided with a first recess 26′ configured to releasably receive and engage the second stable arm end 16B, typically through friction fitting. As will be discussed below, the first joining member end 26A may also be provided with a second recess 26″ configured to releasably receive and engage the second moveable arm end 18B.

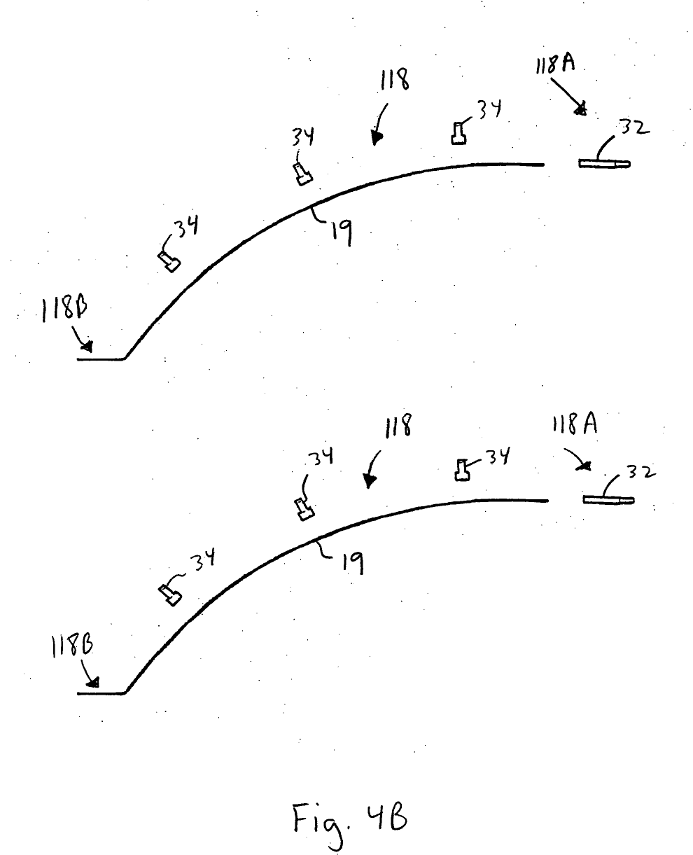

Preferably, as illustrated in FIG. 4A, at least one replacement stable arm 116 will also be provided having a first stable arm end 116A and a second stable arm end 116B. The replacement stable arm 116 will typically have the same general configuration as the stable arm 16. Specifically, the second stable arm end 116B is configured to also be releasably engaged by the joining member 26, and as a result, the second stable arm end 116B is substantially the same size and shape as the second stable arm end 16B.

The replacement stable arm 116 will have a second stiffness, providing a certain desired amount of action. The replacement stable arm 116 stiffness and hence action is intended to differ from the stiffness of the stable arm 16. If a group of replacement stable arms 116, 116′, 116″ is provided, for example as illustrated in FIG. 4A, it is preferable if the stiffness of each replacement stable arm 116 differs from the stiffness of every other replacement stable arm 116 in the group. As well, the length of the replacement stable arms 116, 116′, 116″ may differ from each other if desired.

Preferably the interior region 21 will be sized and configured that it would be able to store at least one stable arm 16 or replacement stable arm 116, when such stable arm 16 (or 116) is not in use.

The main body 19 of the moveable arm 18 will typically be formed of alloy 301 stainless steel or other resilient and sufficiently strong material. The main body 19 of the moveable arm 18 may be flat and formed into an arc, to achieve the desired resiliency or stiffness. The first moveable arm end 18A of the moveable arm 18 is biased with a biasing force to a first position A remote from the first stable arm end 16A. The second moveable arm end 18B may be mounted to and received by the joining member 26.

The moveable arm 18 includes a line guide 32 attached to or otherwise positioned at the free, first moveable arm end 18A. The moveable arm 18 may also have other eyelets or line guides 34 mounted to it. The line guides 34 may be designed with a passage through which the moveable arm 18 may slide, in order to mount the guides 34 to the arm 18 and position them along the arm 18. As can be seen, fishing line 36 may be fed from the reel 14 through the line guides 34, 32 and 30. As will be understood, the reel 14 retains and dispenses the fishing line 36. A fishing lure 40 or other hook may be attached to the free end of the fishing line 36. The joining member 26 may include a hook receiver 42 configured to receive the hook of a lure 40 and hold the lure in place when the fishing rod 10 is not in use.

Preferably, as illustrated in FIG. 4B, at least one replacement moveable arm 118 will also be provided having a first replacement moveable arm end 118A and a second replacement moveable arm end 118B. The replacement moveable arm 118 will typically have the same general configuration as the moveable arm 18. Specifically, the second replacement moveable arm end 118B is configured to also be releasably engaged by the joining member 26, and as a result, the second replaceable moveable arm end 118B is substantially the same size and shape as the second moveable arm end 18B.

The replacement moveable arm 118 will have a second stiffness, providing a certain desired amount of action. The replacement moveable arm 118 stiffness (and specifically the body 19 of the replacement moveable arm 118) and hence action is intended to differ from the stiffness of the moveable arm 18. If a group of replacement moveable arms 118 is provided as shown in FIG. 4B, it is preferable if the stiffness of each replacement moveable arm 118 differs from the stiffness of every other replacement moveable arm 118 in the group, providing the user with different actions to select from.

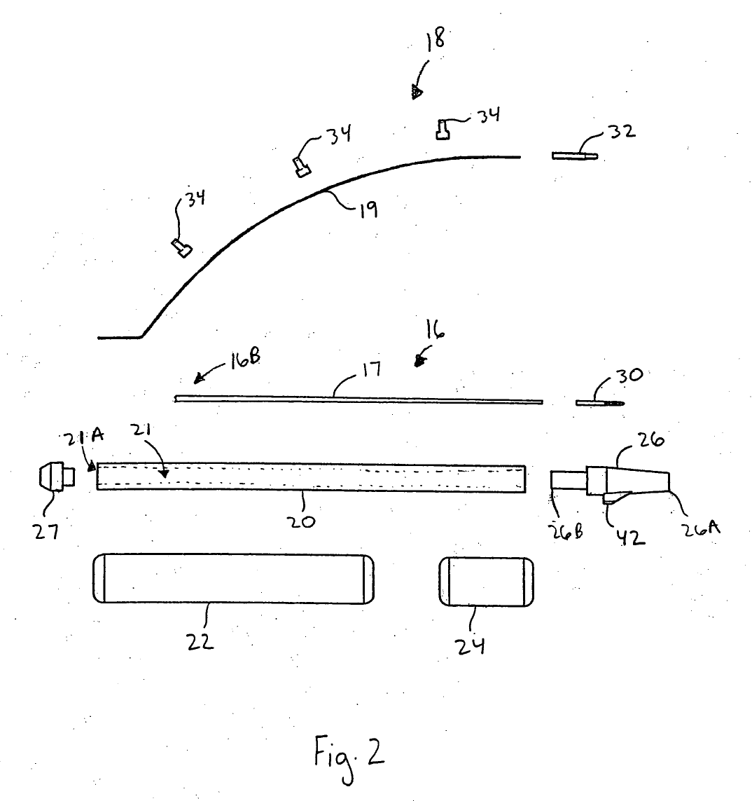

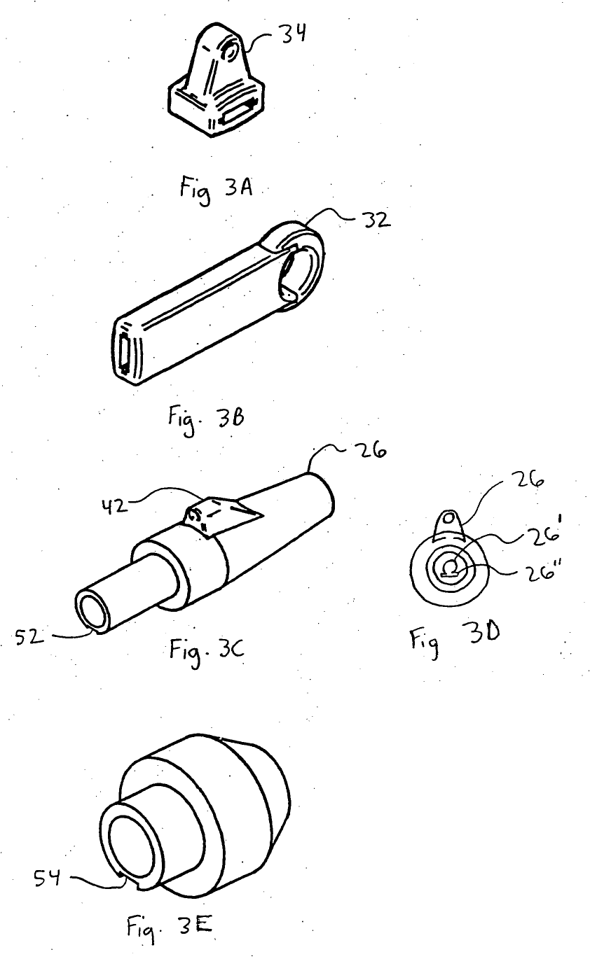

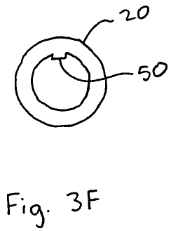

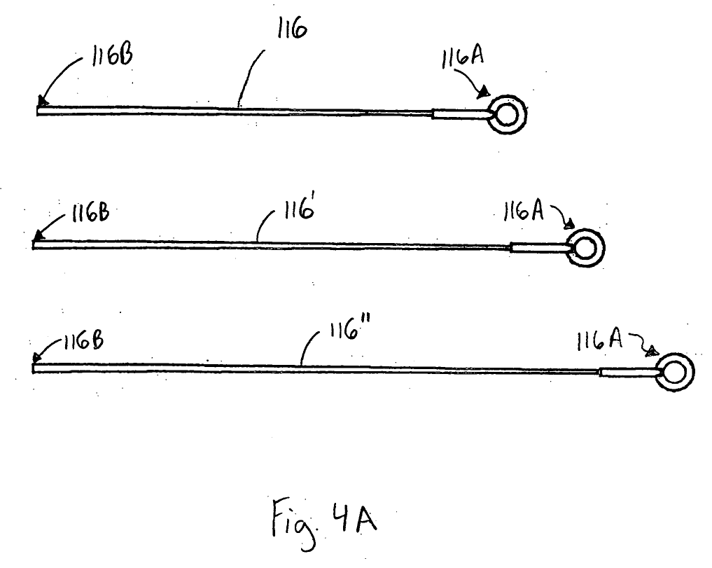

As shown in FIG. 3E, the central cylinder 20 may be provided with a ridge 50 which may be formed of the same material as the cylinder 20, or which may be made of metal or other strengthening material and mounted to the cylinder 20. The ridge 50 may run the length of the cylinder 20, and may be positioned on the interior of the cylinder 20. While the ridge 50 may strengthen the cylinder 20, the ridge 50 may also serve to align the joining member 26 and the butt end 27, which may be provided with corresponding grooves 52, 54 to engage the ridge 50.

As will be understood, the fishing rod 10 may be used with or without a moveable arm 18, 118. In either configuration, a stable arm 16, 116 will be selected from the group of stable arms 16, 116, the selected stable arm 16 having the desired stiffness for the expected fishing conditions and/or fish being sought. The selected stable arm 16, 116 (and specifically the second stable arm end 16B, 116B) will be inserted into and engaged by the joining member 26, which in turn is mounted to the handle 12.

If a moveable arm 18, 118 is also to be used, one with the desired stiffness is selected and the second moveable arm end 18B, 118B will be inserted into and engaged by the joining member 26. Such a configuration is illustrated in FIG. 1A.

Illustrated in FIG. 1B is a second configuration of the fishing rod 10′ having a stable arm 16, 116 mounted to the handle 12. In this configuration, the fishing line 36 passes from the reel 14 and is fed through the line guide 30. If the user wishes to change the action of the rod 10′, for example to adjust to a change in fishing conditions, the user may detach the stable arm 16, 116 from the joining member 26, and select another stable arm 16, 116 which possesses the desired stiffness. The new stable arm 16, 116 is then coupled to the joining member 26.

In use, when there is no tension on the fishing line 36, the first moveable arm end 18A (or 118A) (and line guide 32) remains biased to the first position A remote from the first stable arm end 16A (or 116A) (and line guide 30). When a fish strikes the lure 40, tension is put on the fishing line 36, overcoming the biasing force and causing the first moveable arm end 18A (as shown in dotted outline in FIG. 1) to deflect towards a second position B, with the first moveable arm end 18B in contact with the stable arm 16.

When the first moveable arm end 18A is in the second position B, the moveable arm 18 provides reinforcement to the stable arm 16, and thereby increases the force required to break the stable arm 16. Additionally, as will be understood, the deflection of the moveable arm 18 towards the second position B provides a visual indicator to the user that a fish has struck the lure 40.

In cases of partial fish strikes on the lure 40, the moveable arm 18 may only move partway towards the second position B, and providing a visual indication of the presence of a fish.

As for the stable arm 16, 116, if the user wishes to change the action of the rod 10, for example to adjust to a change in fishing conditions, the user may detach the moveable arm 18, 118 from the joining member 26, and select another moveable arm 18, 118 which possesses the desired stiffness. The new moveable arm 18, 118 is then coupled to the joining member 26.

Thus, while what is shown and described herein constitutes preferred embodiments of the subject invention, it should be understood that various changes can be made without departing from the subject invention, the scope of which is defined in the appended claims.

1. A fishing rod, comprising:
a) a stable arm member having a first stable arm end and a second stable arm end;
b) a joining member having a first joining member end and a second joining member end, wherein the first joining member end is configured to releasably engage the second stable arm end; and
c) a handle having a first handle end and a second handle end, and wherein the first handle end is operatively coupled to the second joining member end.

2. The fishing rod as claimed in claim 1, wherein the first handle end is configured to releasably engage the second joining member end.

3. The fishing rod as claimed in claim 1, wherein the handle is substantially tubular and comprises an interior region.

4. The fishing rod as claimed in claim 3, wherein the interior region is sized to store at least one stable arm member.

5. The fishing rod as claimed in claim 1, further comprising a moveable arm having a first moveable arm end and a second moveable arm end, and wherein the first joining member end is configured to releasably engage the second moveable arm end.

6. At least one additional stable arm member for use with the fishing rod of claim 1, wherein each stable arm member has a different stiffness than every other stable arm member.

7. At least one additional moveable arm for use with the fishing rod of claim 5, wherein each moveable arm has a different stiffness than every other moveable arm.

8. A fishing rod, comprising:
a) a joining member having a first joining member end and a second joining member end, wherein the first joining member end is configured to releasably engage a second stable arm end of a stable arm member having a first stable arm end and the second stable arm end; and
b) a handle having a first handle end and a second handle end, and wherein the first handle end is operatively coupled to the second joining member end.

9. A stable arm member for use with the fishing rod of claim 8, wherein the stable arm comprises the first stable arm end and the second stable arm end.

10. A plurality of stable arm members for use with the fishing rod of claim 8, wherein each stable arm member has a different stiffness than every other stable arm member.

11. A kit comprising:
a) the fishing rod of claim 8; and
b) a plurality of stable arm members, wherein each stable arm member has a different stiffness than every other stable arm member.

12. A fishing rod, comprising:
a) a stable arm member having a first stable arm end and a second stable arm end and;
b) a handle having a first handle end and a second handle end, and wherein the first handle end is configured to releasably engage the second stable arm end.

13. The fishing rod as claimed in claim 12, wherein the handle is substantially tubular and comprises an interior region, and wherein the handle includes an access port through which the interior region may be accessed.

14. The fishing rod as claimed in claim 13, wherein the interior region is sized to store at least one stable arm member.

15. At least one additional stable arm member for use with the fishing rod of claim 12, wherein each stable arm member has a different stiffness than every other stable arm member.

16. The fishing rod as claimed in claim 12, further comprising a moveable arm having a first moveable arm end and a second moveable arm end, and wherein the first handle end is configured to releasably engage the second moveable arm end.

17. At least one additional moveable arm for use with the fishing rod of claim 16, wherein each moveable arm has a different stiffness than every other moveable arm.

18. A fishing rod comprising a handle, wherein the handle is substantially tubular and comprises an interior region, and wherein the handle includes an access port through which the interior region may be accessed.
